(19) United States
(12) Patent Application Publication
(10) Pub. No.: US 2025/0327330 A1
(43) Pub. Date: Oct. 23, 2025

(54) A TENSION BOARD FOR FENCES

(71) Applicant: WIREMAN PTY LIMITED, NEW SOUTH WALES (AU)

(72) Inventor: Ian Lowrey, New South Wales (AU)

(21) Appl. No.: 18/864,071

(22) PCT Filed: May 2, 2023
(86) PCT No.: PCT/AU2023/050365

§ 371 Date: Nov. 8, 2024

(30) Foreign Application Priority Data
May 10, 2022 (AU) 2022901244
Oct. 12, 2022 (AU) 2022902983

(51) Int. Cl. E04H 17/26

(52) U.S. Cl. CPC E04H 17/266

(57) ABSTRACT

A slide saddle (10, 110) for use with a tension board (20, 120) of substantially constant transverse cross-sectional shape for straining mesh style fencing materials is disclosed. The slide saddle comprises a hollow body having an interior shape arranged to slidingly engage the tension board cross-sectional shape, a connector (17, 18) on the body shaped to connect with a wire gripper (25) corresponding to each of the slide saddles (10, 110), and a releasable detent (28) sized to releasably engage with one of a plurality of spaced apart apertures (143) extending along the tension board. A tension board (120) and a method of adjusting the position of the slide saddles on the tension board, are also disclosed.

### FIELD OF THE INVENTION

The present invention relates to fencing and, in particular, to the straining of fences having mesh style fencing materials.

### BACKGROUND ART

International Patent Application No. WO 2020/176936 to the present applicant discloses a tension board for straining mesh style fencing materials normally consisting of wound, or woven, or welded wires which are arranged so as to have a first plurality of spaced apart substantially horizontal wires and a second plurality of spaced apart substantially vertical picket wires.

The above-described tension board has a wire gripper corresponding to each horizontal wire. Since the spacing between the horizontal wires can vary substantially from one type of net style fencing material to another, it is necessary for the position of the wire gripper is on the tension board to be changed from time to time. In the above-mentioned international patent application, this change is brought about by manipulating a fastener, normally having a screw thread of some description, for example, either an eyebolt or a shackle.

### GENESIS OF THE INVENTION

The Genesis of the present invention is a desire to provide a faster way of making this adjustment so as to enable fencing contractors, for example, to quickly change between one style of mesh fencing material to another.

### SUMMARY OF THE INVENTION

In accordance with a first aspect of the present invention there is disclosed a slide saddle for use with a tension board of substantially constant transverse cross-sectional shape for straining mesh style fencing materials having a first plurality of spaced apart substantially horizontal wires and a second plurality of spaced apart substantially vertical wires, said slide saddle comprising a hollow body having an interior shape arranged to slidingly engage said tension board cross-sectional shape, a connector means on said body shaped to connect with a wire gripper corresponding to said slide saddle, and a releasable detent means sized to releasably engage with one of a third plurality of spaced apart apertures extending along said tension board.

In accordance with a second aspect of the present invention there is disclosed a tension board of substantially constant transverse cross-sectional shape for straining mesh style fencing materials having a first plurality of spaced apart substantially horizontal wires and a second plurality of spaced apart substantially vertical wires, said tension board having a fourth plurality of wire grippers each of which extends from a corresponding slide saddle located on said tension board, each said slide saddle being substantially as defined in the above paragraph.

Preferably, each said releasable detent means is releasably engaged with a corresponding one of said third plurality of apertures.

According to another aspect of the present invention there is provided a method of adjusting the location of the slide saddles of the tension board as defined in the above paragraph, said method comprising the steps of actuating said releasable detent means to disengage same from said corresponding aperture, sliding said slide saddle along said tension board, and engaging said releasable detent means with another one of said third plurality of apertures.

### BRIEF DESCRIPTION OF THE DRAWINGS

Several embodiments of the invention will now be described, by way of example only, with reference to the accompanying drawings in which:

FIG. 1 is a perspective view of the slide saddle of a first embodiment,

FIG. 2 is a transverse cross-sectional view through the elongate tension board of a first embodiment,

FIG. 3 is a perspective view of the slide saddle of FIG. 1 connected to a wire gripper,

FIG. 4 is a perspective view of a plurality of the slide saddles and wire grippers of FIG. 3 being connected to the tension board of FIG. 2,

FIG. 5 is a perspective view of the slide saddle of a second embodiment,

FIG. 6 is a transverse cross-sectional view through the elongate tension board of a second embodiment,

FIG. 7 is a perspective view of the slide saddle of FIG. 5 connected to a wire gripper,

FIG. 8 is a perspective view of a plurality of the slide saddles and wire grippers of FIG. 7 being connected to the tension board of FIG. 6,

FIG. 9 is a perspective view of a wire gripper and slide saddle with the swivel shackle located inside a helical coiled spring,

FIG. 10 is a perspective view of a wire gripper and slide saddle with the swivel shackle located inside a length of flexible hose,

FIG. 11 is a perspective view of a wire gripper and slide saddle with the handle ends of the wire gripper interconnected by a length of flexible hose,

FIG. 12 is a perspective view of a slide saddle of a third embodiment,

FIG. 13 is a perspective view of a yoke attachment to be used in conjunction with the slide saddle of FIG. 12

FIG. 14 is a perspective view of the plunger detent in a withdrawn state,

FIG. 15 is a perspective view of the plunger detent in its rest state,

FIG. 16 is a perspective view of the wire gripper attached to the slide saddle of the third embodiment,

FIG. 17 is a perspective view of a foot slide incorporating a plunger detent,

FIG. 18 is a plan view of the foot slide of FIG. 17,

FIG. 19 is a perspective view of one end of a tension board of a third embodiment and showing the inter-engagement of the slide saddle and yoke attachment,

FIG. 20 is a perspective view of the entire tension board of FIG. 19,

FIG. 21 is a perspective view similar to that of FIG. 10 but illustrating the slide saddle of the third embodiment,

FIG. 22 is a perspective view similar to that of FIG. 11 and illustrating the slide saddle of the third embodiment,

FIG. 23 is an exploded perspective view of the tension board of the third embodiment and illustrating an interior joiner,

FIG. 24 is a perspective view of one end of the joiner of FIG. 23,

FIG. 25 is a perspective view of the other end of the joiner of FIG. 23,

FIG. 26 is an exploded perspective view of the joiner of FIG. 23 in use, and

FIG. 27 is a perspective view of two of the tension boards of FIG. 23 joined together utilising the joiner.

### DETAILED DESCRIPTION

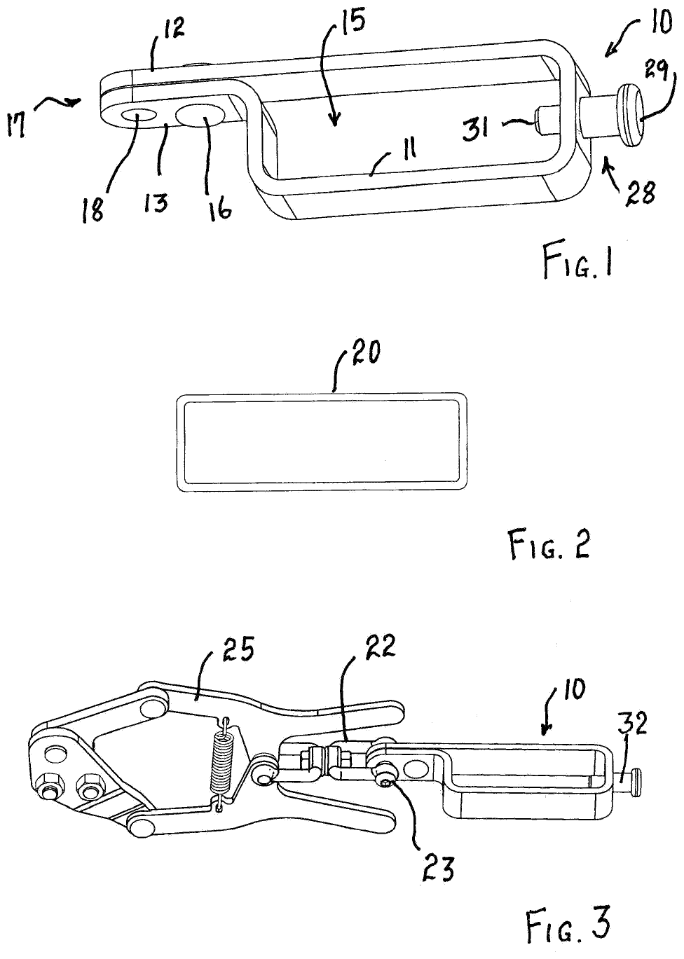

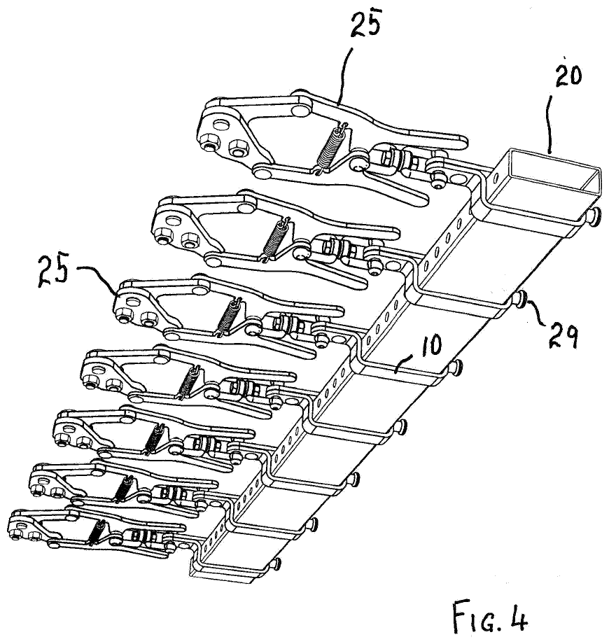

As seen in FIG. 1, a slide saddle 10 of a first embodiment is formed from a strip 11 having two ends 12, 13. The strip 10 is formed into a loop 15 having a rectangular shape which is sized to shape with a tension board 20 as illustrated in FIGS. 2 and 4 hereof and also illustrated in FIGS. 3-4 of the above-mentioned PCT application.

The two ends 12, 13 are joined together by means of a rivet 16 thereby forming a projection 17 which also has a through aperture 18. As seen in FIG. 3, a wire gripper 25 of the type disclosed in WO 2020/051630 is connected to the slide saddle 10 by means of a swivel shackle 22 having a pin 23.

At the end of the loop 15 opposite the projection 17 is a plunger detent 28 having a handle 29 and a plunger 31 each of which extends in opposite directions from a detent body 32. The plunger 31 extends into the rectangular space formed by the loop 15.

As seen in FIG. 4, the tension board 20 can be provided with a plurality (in this instance seven) of slide saddles 10 each of which is slidingly engaged with the tension board 20 and in a position determined by the inter-engagement of the corresponding detent plunger 31 with a corresponding aperture (obscured in FIG. 4 of the present application but illustrated in FIG. 4 of the above-mentioned PCT application). By pulling the handle 29, the detent plunger 31 can be withdrawn into the body 32 of the detent, thereby permitting the corresponding slide saddle 10 to be moved backwards and forwards along the tension board 20. When the desired location of the slide saddle 10 is reached, the handle 29 is released and the interior spring of the detent 28 moves the plunger into the interior of the tension board 20 thereby locking the slide saddle 10 in the desired location. In this way, the position of the slide saddle 10, and its corresponding wire gripper 25, can be moved to accommodate the spacing of the corresponding horizontal wires of the net style fencing material.

In addition, if desired, all the slide saddles 10 and corresponding wire grippers 25 can be removed from the tension board 20 for the purposes of transport or storage, for example, simply by sliding the loops 15 off the tension board 20. Installation, or re-installation, is carried out by reversing the above process.

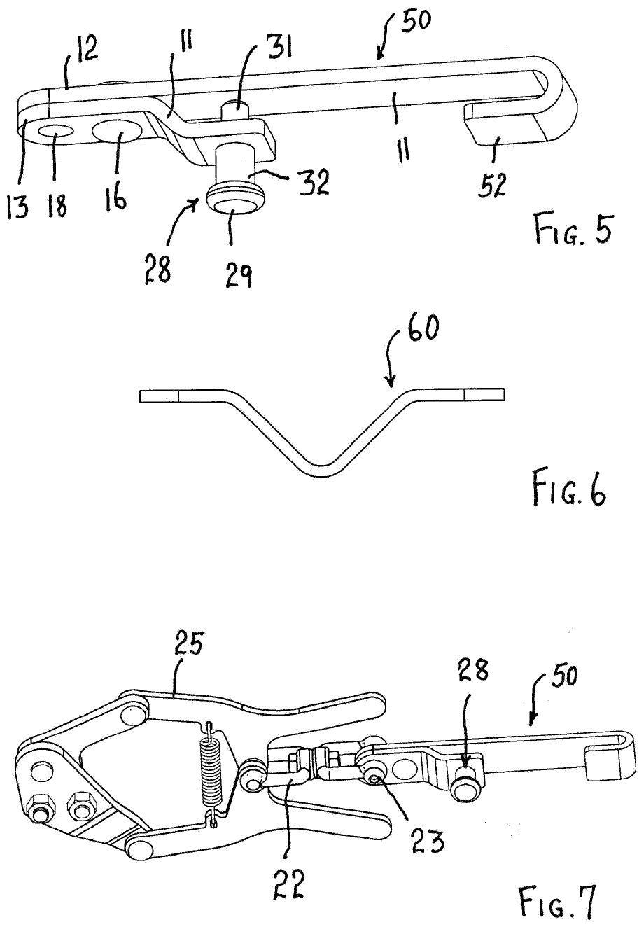

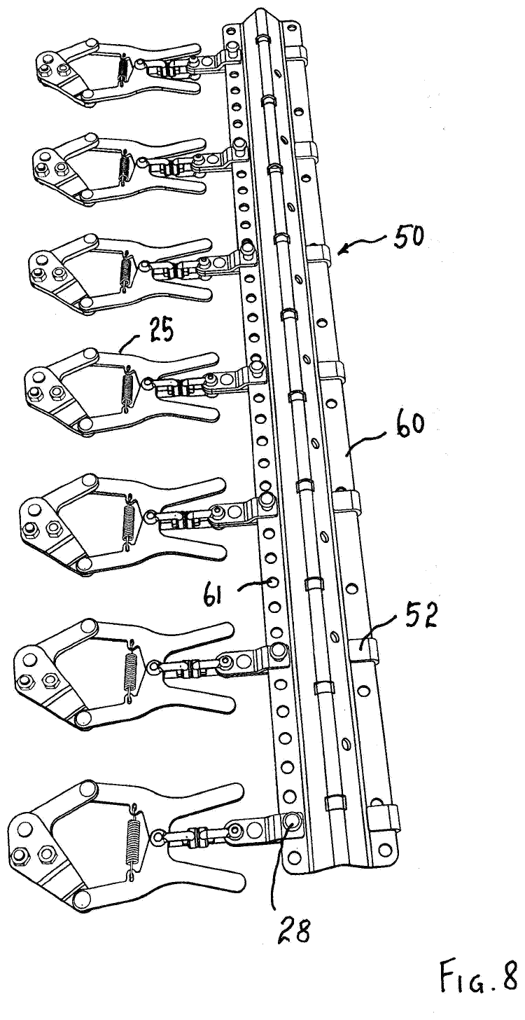

Turning now to FIGS. 5-8, a slide saddle 50 of a second embodiment is illustrated. In this embodiment, the strip 11 and its ends 12, 13 are substantially as before, save that the strip is formed into a C-shaped configuration having two opposing arms 52, 53. The arms 52, 53 are shaped to mate with the side edges of the embodiment of the tension board 60 illustrated in FIGS. 6 and 8. The rivet 16 is as before, however, whilst the arm 52 is unembellished, the arm 53 carries the plunger detent 28.

As seen in FIG. 8, each of the plunger detents 28 is engaged with a corresponding aperture 61 of the tension board 60 thereby determining the location of the corresponding slide saddle 50 on the tension board 60. The installation, location selection, movement, and removal of the slide saddles 50 on the tension board 60 are entirely analogous to the equivalent actions of the slide saddles 10 on the tension board 20.

A further problem of the arrangement illustrated in the above-mentioned PCT application, and in the arrangements as described above in relation to FIGS. 1-8 of the present application, is that when the tension board 20, 60 is substantially vertical, for example, then gravity acts on the wire grippers 25 causing the pin 23 of the swivel shackle 22 to rotate and thereby pivot the wire grippers 25 downwardly. This can represent an inconvenience when connecting, or disconnecting, the wire grippers 25 to the horizontal wires of the wire mesh material.

In order to arrest this downward motion of the wire grippers 25, as seen in FIG. 9, a wire helical spring 71 is located over the swivel shackle 22. This is done prior to joining the wire gripper 25 to the slide saddle 10. That is to say, the pin 23 is inserted through the through aperture 18 in either one of two ways. One way is to pass the pin 23 through the turns of the spring 71 and also pass the Allen key, or other implement used to tighten the pin 23, through the spring 71. The other way is to compress the spring 71, insert the pin 23 and tighten same, and then release the spring 71.

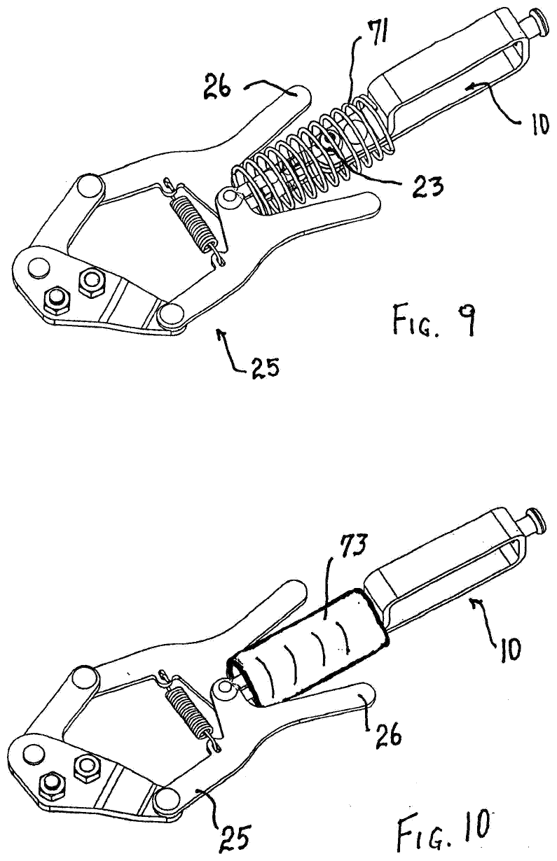

An equivalent embodiment is illustrated in FIG. 10 where the spring 71 is replaced by a short length of flexible hose 73, typically formed from plastic or elastomer material. An aperture, not illustrated in FIG. 10, can be formed in the hose 73 to permit the pin 23 to be inserted and tightened, or loosened and extracted, as the case may be.

A still further inconvenience when connecting, or disconnecting, the wire grippers 25 from the horizontal wires of the mesh material, is that the handles 26 of the wire grippers 25 sometimes get caught in the mesh material. This applies in particular to the vertical wires, or pickets, of the mesh when the grippers 25 are being moved horizontally. In order to ameliorate this inconvenience, the handles 26 are connected to a length of hose 75 as illustrated in FIG. 11. It will be seen that the hose 75 is formed into a bend of relatively large radius which is much less likely to become entangled with the wires than the relatively narrow handles 26. Preferably, the hose 75 is retained on the handles 26 by means of a friction fit and/or heat shrinkage and/or an adhesive.

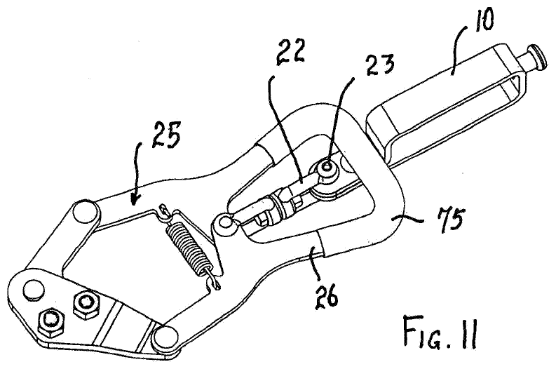

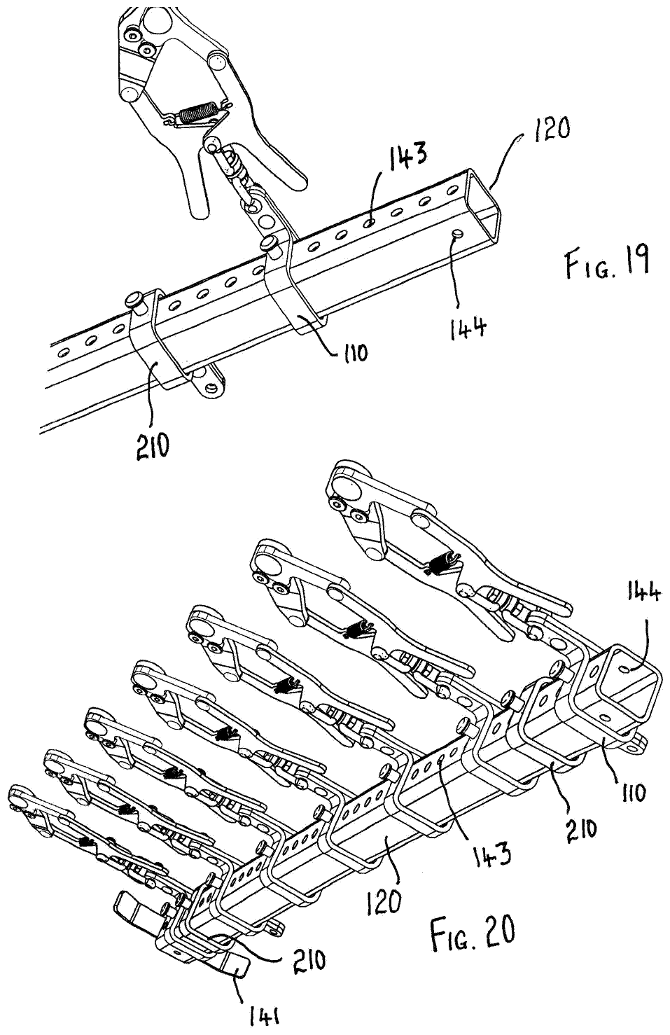

Turning now to FIG. 12, a slide saddle 110 of a third embodiment, and for use with the tension board 120 illustrated in FIGS. 19 and 20 and fabricated from SHS (square hollow section). The slide saddle 110 is substantially similar to the slide saddle 10 except that, firstly, its shape is altered to correspond to that of the tension board 120 and that, secondly, the plunger detent 28 is located adjacent the projection 17. As seen in FIG. 13, a yoke attachment 210 is substantially identical to the slide saddle 110 save that the plunger detent 28 is located opposite to the projection 17.

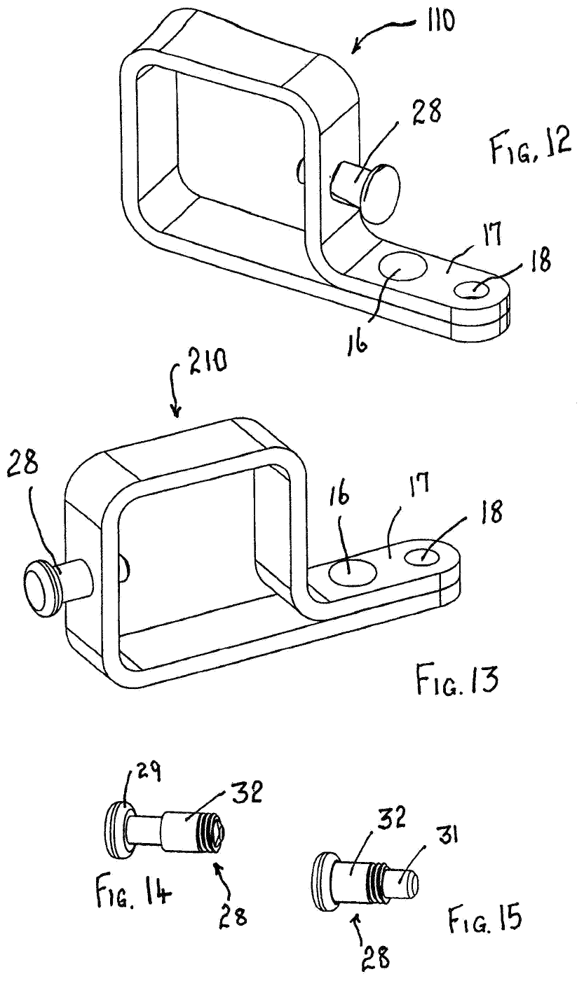

The plunger detent 28 is illustrated in FIGS. 14 and 15 and, as described above, is provided with a handle 29, and a spring-loaded plunger 31 which is housed in the plunger body 32.

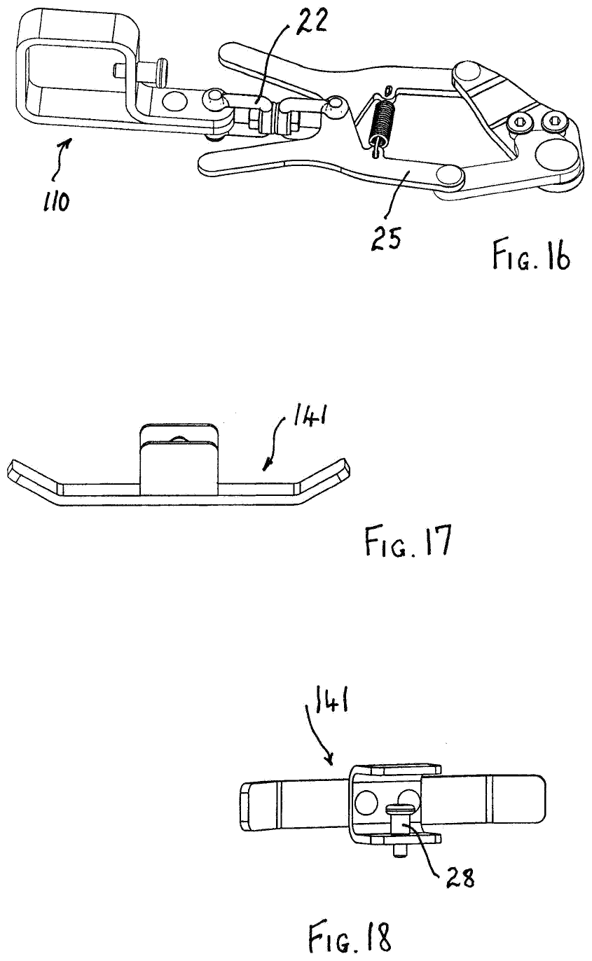

Turning now to FIG. 16, the slide saddle 110 is shown attached to the wire gripper 25 in substantially the same way as was illustrated for FIG. 3 utilising a swivel shackle 22. FIGS. 17 and 18 illustrate a foot slide 141 dimensioned to mate with the tension board 120 of FIGS. 19 and 20. The foot slide 141 includes a plunger detent 28 to enable the foot slide to be releasably connected with either end of the tension board 120 via aperture 144.

As seen in FIGS. 19 and 20, the tension board 120 is provided with a series of regularly spaced apart apertures 143 in only one face of the tension board 120. The slide saddles 110 and yoke attachments 210 are slid onto the tension board 120 so that the plunger detents 28 can engage with selected ones of the apertures 143 and thereby determine the position and spacing of the slide saddles 110 and yoke attachments 210. It will be seen that the projections 17 of the slide saddles 110 and the yoke attachments 210 point in opposite directions. It will also be apparent from FIG. 20 that the foot slide 141 is able to be engaged with either end of the tension board 120 by inter-engaging the plunger 31 of the plunger detent 28 of the foot slide 141 with a corresponding aperture 144 at the end of the tension board 120.

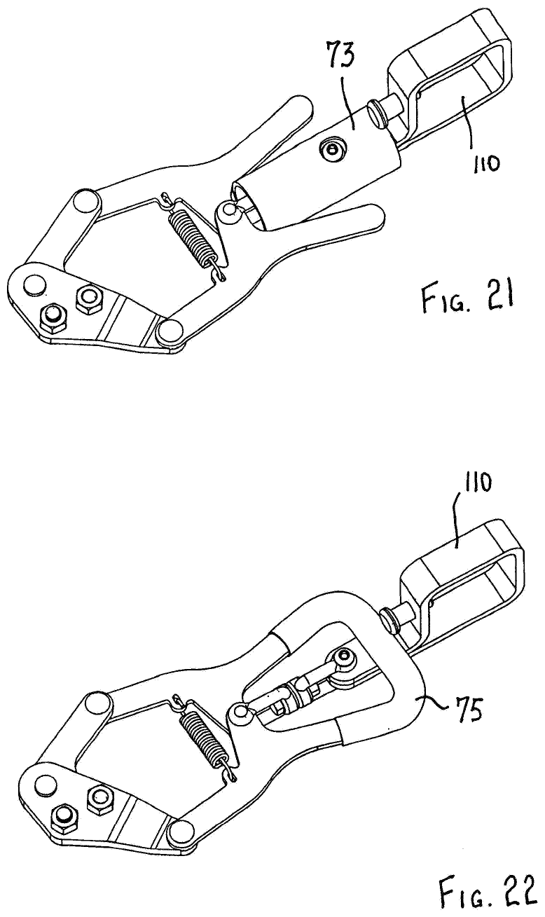

FIGS. 21 and 22, essentially reproduce FIGS. 10 and 11 (but with different slide saddles) and respectively illustrate the positioning of a hose length 73 between the slide saddle 110 and the wire gripper 25, and the use of a length of hose 75 on the wire gripper 25 to prevent the handles thereof from fouling with the wires of the wire mesh to be stretched or tensioned.

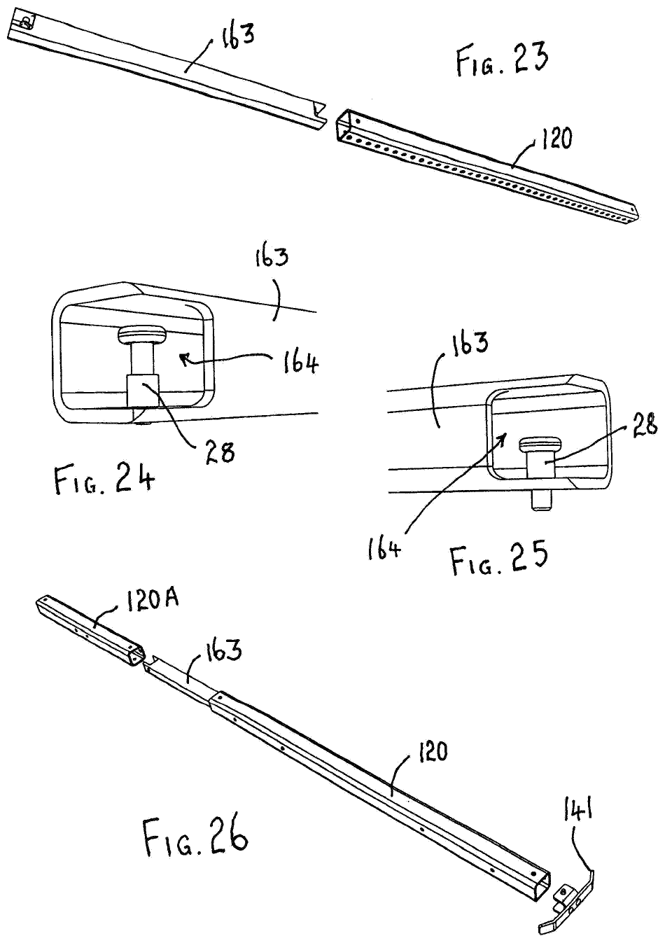

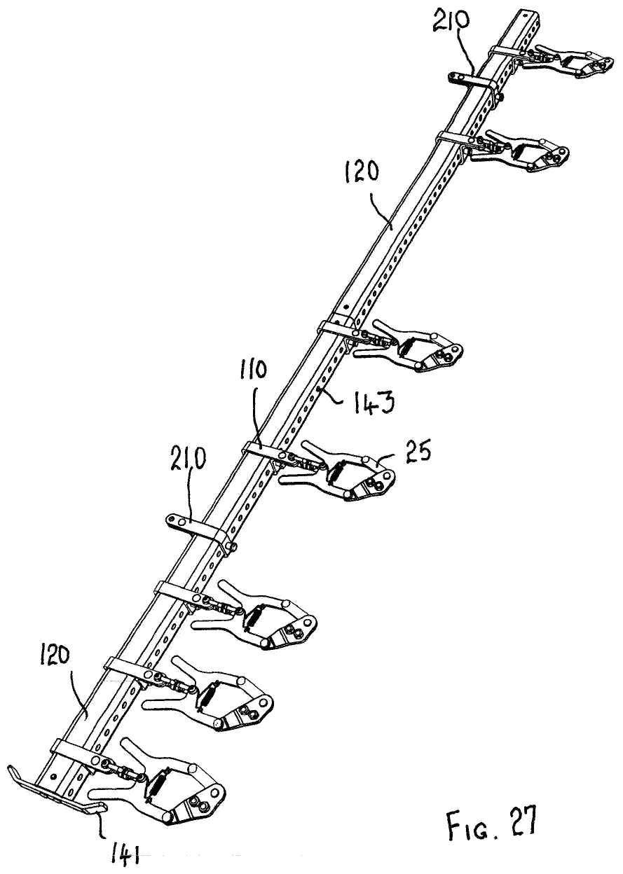

Turning now to FIGS. 23-27, a joiner 163 which enables two of the tension boards 120 to be connected in end to end configuration, is illustrated. The joiner 163 has a cutaway portion 164 at each end which enables the fingers of a user to access the plunger detent 28 located in the interior of each end of the joiner 163. In FIG. 26, a tension board 120 is illustrated being connected with a short length tension board extender 120A whereas in FIG. 27 two full-length tension boards 120 are illustrated joined together in order to illustrate a tension board of approximately 2 m in length which is used to joined together exclusion mesh fencing typically having 16 horizontal wires. In order not to overburden FIG. 27, not all the slide saddles 110 and wire grippers 25 corresponding to the 16 horizontal wires are illustrated.

It will be apparent to those skilled in the art that several advantages arise from the above-mentioned arrangements. In particular, each of the yoke attachments 210 as illustrated in FIG. 27 can be positioned approximately one third of the way along the tension board 120 so as to create a V-shape in a length of chain (not illustrated) used to interconnect two yoke attachments 210. Such a length of chain is typically used by a fencing contractor to connect the tension board to a tractor, telehandler, or similar vehicle, or to a pair of boundary fence strainers, in order to provide a tensioning force.

In addition, as best seen in FIG. 27, the wire grippers 25 and the yoke attachments 210 lie substantially in the same plane to one side of the tension boards 120. Thus, the tensioning force applied via the yoke attachments 210 is directly transmitted to the grippers 25 without applying a twisting torque to the tension board(s) 120.

Furthermore, should it become necessary to operate on the other side of the fence, this can be easily accommodated by moving the foot slide 141 from the lower end of the tension board as illustrated in FIG. 27, and inserting it into the upper end of the tension board. Then the tension board is inverted so that the foot slide 141 is a again adjacent the ground (not illustrated) but the position of the grippers 25 and yoke attachments 210 are reversed.

A further advantage of the tension board 120 of FIGS. 19, 20, 23 and 26 is that they can be joined together using the joiner 163 in a way which permits the slide saddles 110 to slide up and down the tension board without being fouled by any mechanism which joins the tension boards together. For example, the tension board 60 of FIG. 8 is joined to a like board 60 by means of a joining plate which bolts to both boards. Such a joining plate can create a problem in sliding the slide saddles 50 along the joined boards. The internal joiner 163 and tension boards 120 overcome such problems.

In addition, the tension board 120 has only a single row of holes which are required to be punched or drilled or cut into the board whereas the tension board 20 of FIG. 4, for example, has holes on both edges of the tension board. As a consequence, the cost of manufacture of the tension board 120 is reduced.

Furthermore, for waist high fences where only a small number of horizontal wires are required to be simultaneously strained, a lightweight tension board such as the tension board 60 of FIG. 6 can be used. However, for head high exclusion fences where a large number of horizontal wires are required to be simultaneously strained, a stronger tension board such as the tension board 120 of FIG. 27 can be used.

The foregoing describes only some embodiments of the present invention and modifications, obvious to those skilled in the fencing arts, can be made thereto without departing from the scope of the present invention.

The term “comprising” (and its grammatical variations) as used herein is used in the inclusive sense of “including” or “having” and not in the exclusive sense of “consisting only of”.

1. A slide saddle for use with a tension board of substantially constant transverse cross-sectional shape for straining mesh style fencing materials having a first plurality of spaced apart substantially horizontal wires and a second plurality of spaced apart substantially vertical wires, said slide saddle comprising a hollow tubular body having an interior transverse cross-sectional shape arranged to slidingly engage said tension board cross-sectional shape and seat said slide saddle on said tension board, a connector means on said body shaped to connect with a wire gripper corresponding to said slide saddle, and a releasable detent means sized to releasably engage with one of a third plurality of spaced apart apertures extending along said tension board.

2. The slide saddle as claimed in claim 1, wherein said hollow body comprises a looped strip.

3. The slide saddle as claimed in claim 2, wherein said strip has a projection extending therefrom and said connector means comprises an aperture in said projection.

4. The slide saddle as claimed in claim 3, wherein said releasable detent means is located on said strip either opposite said projection or adjacent said projection.

5. The slide saddle as claimed in claim 2, wherein said tension board has a hollow substantially square or substantially rectangular configuration.

6. The slide saddle as claimed in claim 1, wherein said hollow body comprises a strip having a generally C-shaped configuration.

7. The slide saddle as claimed in claim 6, wherein said strip has a projection extending therefrom and said connector means comprises an aperture in said projection.

8. The slide saddle as claimed in claim 7, wherein said releasable detent means is located adjacent said aperture.

9. The slide saddle as claimed in claim 6, wherein said tension board has a solid generally U or V-shaped configuration.

10. The slide saddle as claimed in claim 1. wherein a wire gripper is connected to said connector means via a pivotal joint.

11. The slide saddle as claimed in claim 10, wherein said pivotal joint is located within a flexible helical spring.

12. The slide saddle as claimed in claim 10, wherein said pivotal joint is located within a flexible hose.

13. The slide saddle as claimed in claim 10, wherein said wire gripper has a pair of handles, and a length of flexible hose extends between said handles.

14. A tension board of substantially constant transverse cross-sectional shape for straining mesh style fencing materials having a first plurality of spaced apart substantially horizontal wires and a second plurality of spaced apart substantially vertical wires, said tension board having a fourth plurality of wire grippers each of which extends from a corresponding slide saddle located on said tension board, each said slide saddle being substantially as claimed in claim 1.

15. The tension board as claimed in claim 14, wherein each said releasable detent means is releasably engaged with a corresponding one of said third plurality of apertures.

16. A method of adjusting the location of the slide saddles of the tension board as claimed in claim 14, said method comprising the steps of actuating said releasable detent means to disengage same from said corresponding aperture, sliding said slide saddle along said tension board, and engaging said releasable detent means with another one of said third plurality of apertures.

17. A tension board as claimed in claim 14, wherein said slide saddle connector means of said slide saddles are all located in a plane positioned to one side of said tension board.
